(19) United States
(12) Patent Application Publication
(10) Pub. No.: US 2024/0388949 A1
(43) Pub. Date: Nov. 21, 2024

(54) APPARATUS COMPRISING AT LEAST ONE PROCESSOR

(71) Applicant: Nokia Technologies Oy, Espoo (FI)

(72) Inventors: Philippe Godin, Versailles (FR); Halit Murat Guersu, Munich (DE); Omer Bulakci, Munich (DE); Gyoergy Tamas Wolfner, Budapest (HU); Malgorzata Tomala, Wroclaw (PL); Muhammad Nasser-Ul-Islam, Munich (DE)

(21) Appl. No.: 18/693,052

(22) PCT Filed: Sep. 16, 2021
(86) PCT No.: PCT/EP2021/075519

§ 371 Date: Mar. 18, 2024

(51) Int. Cl. H04W 28/02; H04W 28/086; H04W 48/20

(52) U.S. Cl. CPC H04W 28/0226; H04W 28/0862; H04W 48/20

(57) ABSTRACT

An apparatus, comprising at least one processor, and at least one memory storing instructions, the at least one memory and the instructions configured to, with the at least one processor, cause a network node to transmit a first information to at least one terminal device, wherein the first information characterizes at least one cell and/or frequency of a radio access network notification area, RNA, which is overloaded for at least one slice associated with an existing PDU session of the at least one terminal device.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment, and one or more network devices such as e.g. base stations.

Some wireless communications systems such as, for example, 5G systems may provide a feature referred to as “network slicing” which enables to support different services using a same underlying mobile network infrastructure. Network slices can differ either in their service requirements like Ultra-Reliable Low Latency Communication (URLLC) and enhanced Mobile Broadband (eMBB) or the tenant that provides those services.

In some configurations, network slices may be identified via S-NSSAI (Single-Network Slice Selection Assistance Information). Current 3GPP (Third Generation Partnership Project) specifications allow a user equipment to be simultaneously connected and served by at most eight network slices, corresponding to eight S-NSSAIs. On the other hand, a cell may support tens or even hundreds of S-NSSAIs, e.g., in some current specifications a tracking area (TA) can support up to 1024 network slices.

In some configurations, the S-NSSAI may include both a Slice Service Type (SST) and a Slice Differentiator (SD) field or may include an SST field part. In some conventional systems, the SST field may have standardized and non-standardized values. In some configurations, values 0 to 127 belong to the standardized SST range. For instance, an SST value of “1” may indicate that the slice is suitable for handling of 5G eMBB, “2” for handling of URLLC, etc.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus, comprising at least one processor, and at least one memory storing instructions, the at least one memory and the instructions configured to, with the at least one processor, cause a network node to transmit a first information to at least one terminal device, wherein the first information characterizes at least one cell and/or frequency of a radio access network notification area, RNA, which is overloaded for at least one slice associated with an existing PDU session of the at least one terminal device. In some embodiments, this may increase a probability of successful service continuity for the terminal device, e.g. when reconnecting to a cell of the radio access network notification area.

I.e., in other words, the first information characterizes at least one cell and/or frequency of a radio access network notification area, RNA, wherein the at least one cell and/or frequency is overloaded for at least one slice associated with an existing PDU session of the at least one terminal device.

In some embodiments, the apparatus may be an apparatus for a wireless communications system.

In some embodiments, the apparatus or its functionality, respectively, may be provided in a network device, for example network node, of the communications system, for example in a base station, e.g. gNodeB (gNB), for example in an anchor gNB, e.g. last serving gNB.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation), beyond 5G, e.g., 6G, or other radio access technology.

In some embodiments, the network node may be a last serving node, for example last serving NG-RAN (Next Generation Radio Access Network) node of terminal device, e.g. user equipment, before the terminal device is sent in a radio resource control, RRC, inactive state, e.g. an RRC INACTIVE state according to some accepted standards.

In some embodiments, the instructions, when executed by the at least one processor, cause the network node to receive a slice overload information characterizing at least one of: a) an overload condition of a slice supported by a specific cell, b) an estimated duration of an overload condition of a slice supported by a specific cell. In some embodiments, the slice overload information may be received by the network node via Xn signaling, e.g. an XnAP (Xn Application Protocol) message, according to some accepted standard, e.g. from another gNB, e.g. peer gNB, e.g. if a respective cell associated with the slice overload information belongs to the other gNB.

In some embodiments, the first information may be transmitted by the network node to the at least one terminal device based on the slice overload information.

In some embodiments, the first information may be transmitted repeatedly, for example periodically or event-triggered. In some embodiments, the first information may be transmitted based on at least one of an update of the radio access network notification area and a connected transaction. In some embodiments, the first information may be transmitted when the network node decides to send the terminal device, e.g. UE, to RRC INACTIVE state.

In some embodiments, the instructions, when executed by the at least one processor, cause the network node to transmit the first information in a radio resource control, RRC, Release message, e.g. in an RRC RELEASE message according to some accepted standard.

In some embodiments, the network node may decide to move the at least one terminal device into an RRC INACTIVE state using the RRC Release message, e.g. with suspend indication and a configured radio access network notification area. In some embodiments, the first information may be transmitted within such RRC Release message suspending the at least one terminal device into the RRC_INACTIVE state.

In some embodiments, the first information comprises at least one of: a) a list of cells (e.g., list of cell IDs) of the radio access network notification area, RNA, which is overloaded for at least one slice associated with an existing PDU session of the at least one terminal device, b) for at least one cell of a or the list of cells (e.g. the list of cells mentioned in item a) above), slice information identifying at least one overloaded slice of the at least one cell, c) an estimated duration of an overload condition of a slice supported by the specific cell, e.g. in the form of a timer or timer value, respectively, corresponding to an anticipated expected duration for the overload condition. In some embodiments, the network node, e.g. anchor gNB may have received the timer value from a peer gNB, e.g. over an Xn interface.

In some embodiments, the first information comprises at least one of: a) a list of frequencies of the radio access network notification area, RNA, which is overloaded for at least one slice associated with an existing PDU session of the at least one terminal device, b) at least for one frequency of the above list slice information identifying at least one overloaded slice of the frequency, c) an estimated duration of an overload condition of a slice supported by the specific frequency, e.g. in the form of a timer or timer value, respectively, corresponding to an anticipated expected duration for the overload condition. In some embodiments, the network node, e.g. anchor gNB, may have received the timer value from a peer gNB, e.g. over an Xn interface.

In some embodiments, the first information comprises for at least one cell of a or the list of cells, slice group information identifying at least one overloaded slice of the at least one cell and/or at least one overloaded slice group of the at least one cell.

In some embodiments, the first information comprises at least one bandwidth part (BWP), which is overloaded for at least one slice and/or slice group associated with an existing PDU session of the at least one terminal device. In some embodiments, the instructions, when executed by the at least one processor, cause the network node to determine, based on a threshold associated with the load of a specific cell, to which terminal devices the first information should be sent, and to transmit the first information to the determined terminal devices. As an example, in some embodiments, the network node, e.g. anchor gNB, may condition a transmission of the first information, e.g. comprising the list of cell IDs, to a given overload threshold reached and may accordingly transmit the first information not to all terminal devices, e.g. UEs, but rather a specific group of UEs. For example, in some embodiments, the anchor gNB may decide to send the first information if a load threshold is higher than e.g. 80%, and then the anchor gNB may decide to send the first information selectively to some UEs (e.g., not all UEs), for example targeting at distributing the load. In some embodiments, this may enable a better load balancing/distribution.

Further exemplary embodiments relate to a method comprising: transmitting, by a network node, a first information to at least one terminal device, wherein the first information characterizes at least one cell and/or frequency of a radio access network notification area, RNA, which is overloaded for at least one slice associated with an existing PDU session of the at least one terminal device.

Further exemplary embodiments relate to a method comprising: transmitting, by a network node, a first information to at least one terminal device, wherein the first information characterizes at least one cell of a radio access network notification area, RNA, which is overloaded for at least one slice associated with a list of allowed slices of the at least one terminal device.

Further exemplary embodiments relate to an apparatus comprising means for transmitting a first information to at least one terminal device, wherein the first information characterizes at least one cell and/or frequency of a radio access network notification area, RNA, which is overloaded for at least one slice associated with an existing PDU session of the at least one terminal device. In some embodiments, the means for transmitting the first information may e.g. comprise at least one processor, and at least one memory storing instructions, the at least one memory and the instructions configured to, with the at least one processor, perform said steps.

Further exemplary embodiments relate to an apparatus, comprising at least one processor, and at least one memory storing instructions, the at least one memory and the instructions configured to, with the at least one processor, cause a terminal device to receive, and optionally store, a first information which characterizes at least one cell and/or frequency of a radio access network notification area, RNA, which is overloaded for at least one slice associated with an existing PDU session of the terminal device.

In some embodiments, the received first information may be stored because it may be used later, e.g. during a future subsequent cell selection/reselection process, i.e. the first information is received at time T1 but used later at a time T2>T1, e.g. when a need for cell reselection occurs.

In some embodiments, the received first information may be used along with the received cell reselection priorities/sub-priorities, e.g., via RRC Release, or the received cell reselection priority/sub-priority, e.g., via system information, for cell reselection.

In some embodiments, the first information can be sent by the network to the terminal devices as part of the cell reselection priorities/sub-priorities. In some embodiments, cell reselection priorities/sub-priorities can be determined based on the first information.

Further exemplary embodiments relate to an apparatus, comprising at least one processor, and at least one memory storing instructions, the at least one memory and the instructions configured to, with the at least one processor, cause a terminal device to receive and store a first information which characterizes at least one frequency of a radio access network notification area, RNA, which is overloaded for at least one slice associated with an existing PDU session of the terminal device.

In some embodiments, the apparatus may be an apparatus for a wireless communications system.

In some embodiments, the apparatus or its functionality, respectively, may be provided in a terminal device, for example user equipment (UE), of the communications system.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the instructions, when executed by the at least one processor, cause the terminal device to perform a cell selection or cell re-selection taking into account the first information, e.g. the stored first information. In some embodiments, this way, the mobile terminal may take into account potential overload conditions of slices.

In some embodiments, taking into account the first information comprises deprioritizing the at least one cell in the cell selection or re-selection.

In some embodiments, taking into account the first information comprises deprioritizing the frequency of the at least one cell in the cell selection or re-selection.

Further exemplary embodiments relate to a method comprising: receiving, and optionally storing, by a terminal device, first information, which characterizes at least one cell and/or frequency of a radio access network notification area, RNA, which is overloaded for at least one slice associated with an existing PDU session of the terminal device.

Further exemplary embodiments relate to an apparatus comprising means for receiving, and optionally storing, first information, which characterizes at least one cell and/or frequency of a radio access network notification area, RNA, which is overloaded for at least one slice associated with an existing PDU session of the terminal device. In some embodiments, the means for receiving the first information may e.g. comprise at least one processor, and at least one memory storing instructions, the at least one memory and the instructions configured to, with the at least one processor, perform said steps.

Further exemplary embodiments relate to an apparatus comprising means for receiving, and optionally storing, first information, which characterizes at least one cell of a radio access network notification area, RNA, which is overloaded for at least one slice comprised in a list of allowed slices of the terminal device.

Further exemplary embodiments relate to an apparatus comprising means for receiving, and optionally storing, first information, which characterizes at least one frequency of a radio access network notification area, RNA, which is overloaded for at least one slice comprised in a list of allowed slices of the terminal device.

Further exemplary embodiments relate to an apparatus, comprising at least one processor, and at least one memory storing instructions, the at least one memory and the instructions configured to, with the at least one processor, cause a network node to transmit a slice overload information characterizing at least one of: a) an overload condition of a slice supported by a specific cell, b) an estimated duration of an overload condition of a slice supported by the specific cell. In some embodiments, this may enable a further network node, e.g. an anchor gNB, to which the slice overload information is transmitted, to provide the first information according to the embodiments, e.g. based on the received slice overload information, to at least one terminal device.

Further exemplary embodiments relate to an apparatus, comprising at least one processor, and at least one memory storing instructions, the at least one memory and the instructions configured to, with the at least one processor, cause a network node to transmit a slice overload information characterizing at least one of: a) an overload condition of a slice supported by a specific frequency, b) an estimated duration of an overload condition of a slice supported by the specific frequency. In some embodiments, this may enable a further network node, e.g. an anchor gNB, to which the slice overload information is transmitted, to provide the first information according to the embodiments, e.g. based on the received slice overload information, to at least one terminal device.

Further exemplary embodiments relate to a method comprising: transmitting, by a network node, a slice overload information characterizing at least one of: a) an overload condition of a slice supported by a specific cell, b) an estimated duration of an overload condition of a slice supported by a specific cell.

Further exemplary embodiments relate to a method comprising: transmitting, by a network node, a slice overload information characterizing at least one of: a) an overload condition of a slice supported by a specific frequency, b) an estimated duration of an overload condition of a slice supported by the specific frequency.

In some embodiments, the slice overload information characterizes at least one of: a) an overload condition of a slice supported by a specific cell, b) an estimated duration of an overload condition of a slice supported by a specific cell, c) an overload condition of a slice supported by a specific frequency, d) an estimated duration of an overload condition of a slice supported by the specific frequency.

Further exemplary embodiments relate to an apparatus comprising means for transmitting a slice overload information characterizing at least one of: a) an overload condition of a slice supported by a specific cell, b) an estimated duration of an overload condition of a slice supported by a specific cell. In some embodiments, the means for transmitting the slice overload information may e.g. comprise at least one processor, and at least one memory storing instructions, the at least one memory and the instructions configured to, with the at least one processor, perform said steps.

Further embodiments relate to a communications system comprising at least one apparatus according to the embodiments.

Further embodiments relate to a computer program comprising instructions which, when the program is executed by a computer, cause the computer to carry out the method according to the embodiments. In some embodiments, the computer program may be stored on a non-transitory computer readable storage medium.

Further embodiments relate to a data carrier signal carrying the computer program according to the embodiments.

Further embodiments relate to a use of the apparatus according to the embodiments and/or of the method according to the embodiments and/or of the computer program according to the embodiments and/or of the data carrier signal according to the embodiments for at least one of: a) providing at least one terminal device, e.g. user equipment, with the first information, b) increasing a probability of successful service continuity for the at least one terminal device, e.g. when reconnecting to a cell of the radio access network notification area, c) load balancing.

Further embodiments include increasing a probability of successful service continuity for at least one terminal device by deprioritizing the received cell or frequency during subsequent cell reselection processes so that the slice of the terminal device has a higher probability of getting accepted when later on the terminal device reconnects to a cell of the radio access network notification area.

### BRIEF DESCRIPTION OF THE FIGURES

FIG. 1 schematically depicts a simplified block diagram according to some embodiments,

FIG. 2 schematically depicts a simplified block diagram according to some embodiments,

FIG. 3 schematically depicts a simplified block diagram according to some embodiments,

FIG. 4 schematically depicts a simplified flow chart according to some embodiments,

FIG. 5 schematically depicts a simplified block diagram according to some embodiments,

FIG. 6 schematically depicts a simplified flow chart according to some embodiments,

FIG. 7 schematically depicts a simplified flow chart according to some embodiments,

FIG. 8 schematically depicts a simplified signalling diagram according to some embodiments,

FIG. 9 schematically depicts a simplified block diagram according to some embodiments,

FIG. 10 schematically depicts a simplified block diagram according to some embodiments,

FIG. 11 schematically depicts a simplified block diagram according to some embodiments,

FIG. 12 schematically depicts a simplified block diagram according to some embodiments.

### DESCRIPTION OF SOME EXEMPLARY EMBODIMENTS

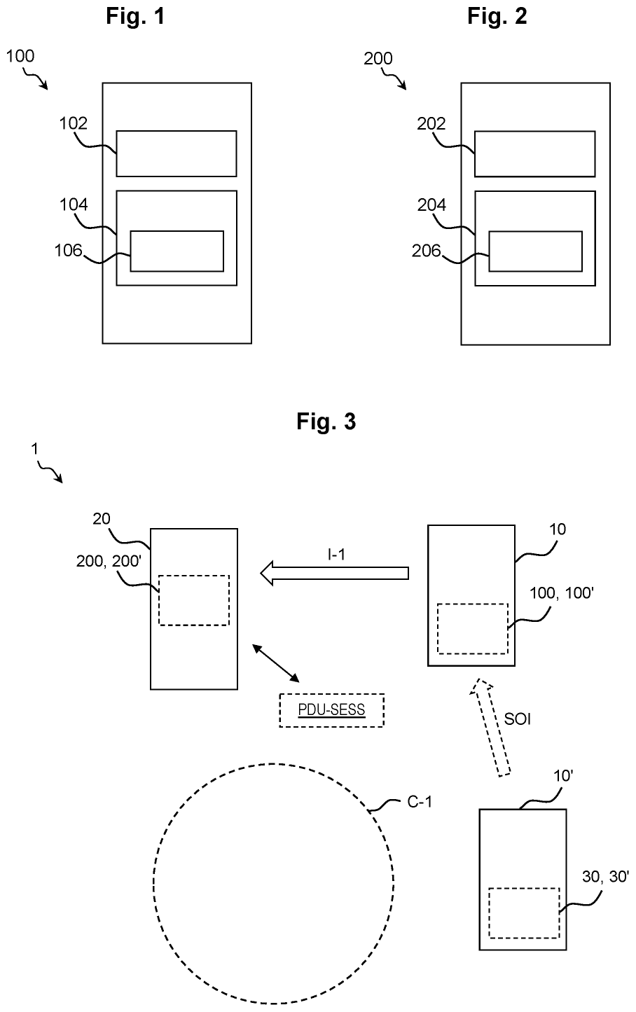

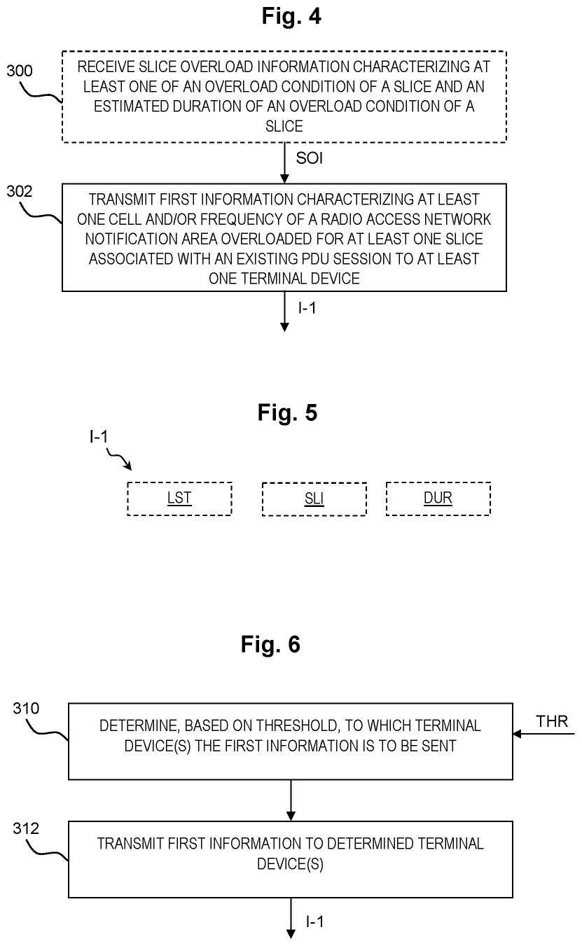

Some embodiments, see for example FIG. 1, 3, 4, relate to an apparatus 100 (FIG. 1), comprising at least one processor 102, and at least one memory 104 storing instructions 106, the at least one memory 104 and the instructions 106 configured to, with the at least one processor 102, cause a network node 10 (FIG. 3) to transmit 302 (FIG. 4) a first information I-1 to at least one terminal device 20 (FIG. 3), wherein the first information I-1 characterizes at least one cell C-1 and/or frequency of a radio access network notification area, RNA, which is overloaded for at least one slice associated with an existing PDU session PDU-SESS of the at least one terminal device 20. In some embodiments, this may increase a probability of successful service continuity for the terminal device 20, e.g. when reconnecting to a cell of the radio access network notification area.

In some embodiments, the apparatus 100 may be an apparatus for a wireless communications system 1.

In some embodiments, the apparatus 100 or its functionality, respectively, may be provided in a network device, for example network node, 10 of the communications system, for example in a base station, e.g. gNodeB (gNB), 10, for example in an anchor gNB, e.g. last serving gNB.

In some embodiments, the apparatus 100 according to the embodiments or its functionality, respectively, may be used for or within wireless communications systems, e.g. networks, 1 based on or at least partially adhering to third generation partnership project, 3GPP, radio standards such as 5G (fifth generation) or other radio access technology.

In some embodiments, the network node 10 may be a last serving node, for example last serving NG-RAN (Next Generation Radio Access Network) node of terminal device, e.g. user equipment, 20 before the terminal device 20 is sent in a radio resource control, RRC, inactive state, e.g. an RRC INACTIVE state according to some accepted standards.

In some embodiments, the instructions 106 (FIG. 1), when executed by the at least one processor 102, cause the network node 10 to receive 300 (FIG. 4) a slice overload information SOI characterizing at least one of: a) an overload condition of a slice supported by a specific cell, b) an estimated duration of an overload condition of a slice supported by a specific cell. In some embodiments, the slice overload information SOI may be received by the network node 10 via Xn signaling, e.g. an XnAP (Xn Application Protocol) message, according to some accepted standard, e.g. from another gNB, e.g. peer gNB, 10′ (FIG. 3), e.g. if a respective cell associated with the slice overload information belongs to the other gNB 10′.

In some embodiments, the first information I-1 may be transmitted by the network node 10 to the at least one terminal device 20 based on the slice overload information SOI.

In some embodiments, the first information I-1 may be transmitted repeatedly, for example periodically or event-triggered. In some embodiments, the first information I-1 may be transmitted based on at least one of an update of the radio access network notification area and a connected transaction. In some embodiments, the first information I-1 may be transmitted when the network node 10 wants to send the user equipment 20 into RRC_INACTIVE state.

In some embodiments, the instructions 106, when executed by the at least one processor 102, cause the network node 10 to transmit 302 the first information I-1 in a radio resource control, RRC, Release message e4 (FIG. 8), e.g. in an RRC RELEASE message according to some accepted standard.

In some embodiments, the network node 10 may decide to move the at least one terminal device 20 into an RRC INACTIVE state using the RRC Release message e4, e.g. with suspend indication and a configured radio access network notification area. In some embodiments, the first information I-1 may be transmitted within such RRC Release message e4 suspending the at least one terminal device 20 into the RRC_INACTIVE state.

In some embodiments, FIG. 5, the first information I-1 comprises at least one of: a) a list LST of cells (e.g., list of cell IDs) of the radio access network notification area, RNA, which is overloaded for at least one slice associated with an existing PDU session PDU-SESS (FIG. 3) of the at least one terminal device 20, b) slice information SLI (FIG. 5) identifying for at least one of the cells of the list LST at least one overloaded slice of a cell of the RNA, c) an estimated duration (DUR) of an overload condition of a slice supported by a specific cell, e.g. in the form of a timer or timer value, respectively, corresponding to an anticipated expected duration for the overload condition.

In some embodiments, the network node 10, e.g. anchor gNB, may have received the timer value from a peer gNB 10′, e.g. over an Xn interface.

In some embodiments, FIG. 6, the instructions 106, when executed by the at least one processor 102, cause the network node 10 to determine 310, based on a threshold THR, to which terminal devices 20 the first information I-1 should be sent, and to transmit 312 the first information I-1 to the determined terminal devices. As an example, in some embodiments, the network node, e.g. anchor gNB, 10 may condition a transmission of the first information I-1, e.g. comprising the list of cell IDs, to a given overload threshold reached and may accordingly transmit the first information not to all terminal devices, e.g. UEs, but rather a specific group of UEs 20. For example, in some embodiments, the anchor gNB 10 may decide to send the first information I-1 if a load threshold is higher than e.g. 80%, and then the anchor gNB 10 may decide to send the first information I-1 selectively to some UEs 20 (e.g., not all UEs), for example targeting at distributing a load. In some embodiments, this may enable a better load balancing/distribution.

Further exemplary embodiments, FIG. 4, relate to a method comprising: transmitting 302, by a network node 10, a first information I-1 to at least one terminal device 20, wherein the first information I-1 characterizes at least one cell C-1 and/or frequency of a radio access network notification area, RNA, which is overloaded for at least one slice associated with an existing PDU session PDU-SESS of the at least one terminal device 20.

Further exemplary embodiments, FIG. 10, relate to an apparatus 100′ comprising means 102′ for transmitting 302 a first information I-1 to at least one terminal device 20, wherein the first information I-1 characterizes at least one cell C-1 and/or frequency of a radio access network notification area, RNA, which is overloaded for at least one slice associated with an existing PDU session PDU-SESS of the at least one terminal device 20. In some embodiments, the means 102′ for transmitting 302 the first information I-1 may e.g. comprise at least one processor 102, and at least one memory 104 storing instructions 106, the at least one memory 104 and the instructions 106 configured to, with the at least one processor 102, perform said step(s).

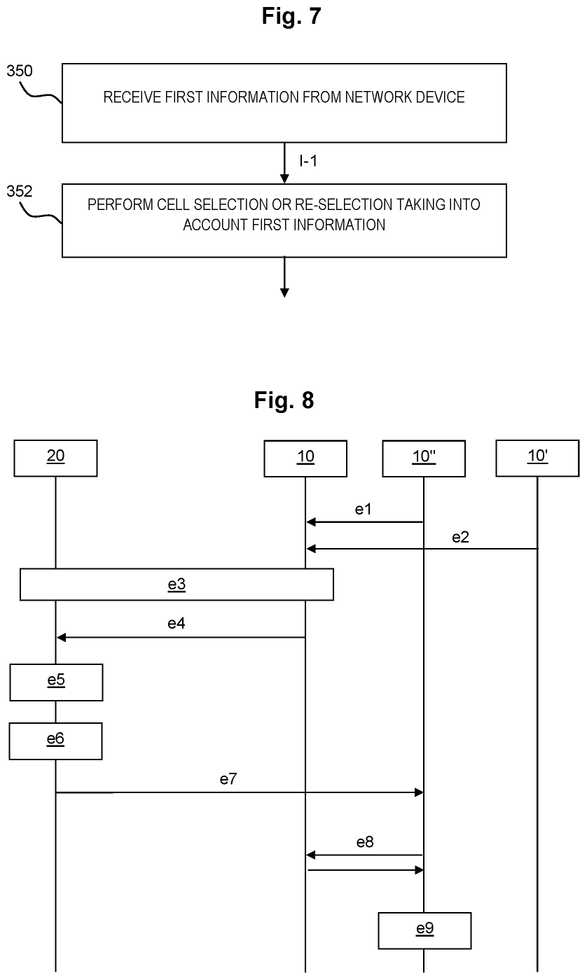

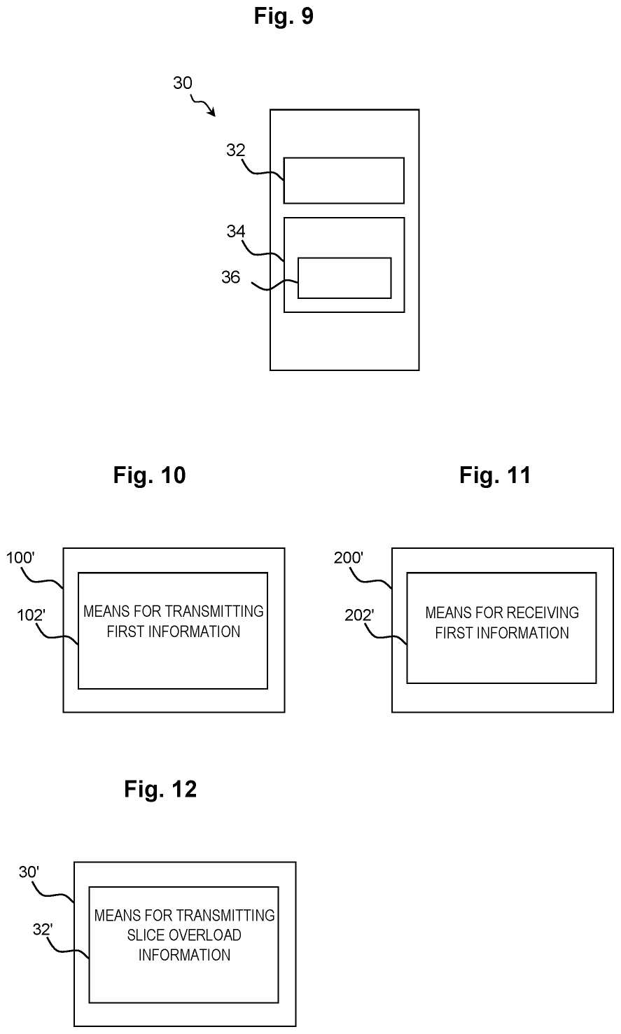

Further exemplary embodiments, FIG. 2, 3, 7, relate to an apparatus 200, comprising at least one processor 202, and at least one memory 204 storing instructions 206, the at least one memory 204 and the instructions 206 configured to, with the at least one processor 202, cause a terminal device 20 to receive 350 (FIG. 7), and optionally store, a first information I-1 which characterizes at least one cell C-1 and/or frequency of a radio access network notification area, RNA, which is overloaded for at least one slice associated with an existing PDU session PDU-SESS of the terminal device 20.

In some embodiments, the apparatus 200 may be an apparatus for a wireless communications system 1.

In some embodiments, the apparatus 200 or its functionality, respectively, may be provided in a terminal device, for example user equipment (UE), 20 of the communications system 1.

In some embodiments, the apparatus 200 according to the embodiments or its functionality, respectively, may be used for or within wireless communications systems, e.g. networks, 1 based on or at least partially adhering to third generation partnership project, 3GPP, radio standards such as 5G (fifth generation), beyond 5G, e.g., 6G, or other radio access technology.

In some embodiments, the instructions 206, when executed by the at least one processor 202, cause the terminal device 20 to perform 352 a cell selection or cell re-selection taking into account the first information I-1. In some embodiments, this way, the mobile terminal 20 may take into account potential overload conditions of the involved slices, e.g. to deprioritize the cell.

In some embodiments, taking into account the first information I-1 comprises deprioritizing the at least one cell in the cell selection or re-selection.

In some embodiments, taking into account the first information I-1 comprises deprioritizing the frequency of the at least one cell in the cell selection or re-selection.

Further exemplary embodiments, FIG. 7, relate to a method comprising: receiving 350, and optionally storing, by a terminal device 20, a first information I-1, which characterizes at least one cell C-1 and/or frequency of a radio access network notification area, RNA, which is overloaded for at least one slice associated with an existing PDU session PDU-SESS of the terminal device 20.

Further exemplary embodiments, FIG. 11, relate to an apparatus 200′ comprising means 202′ for receiving 350, and optionally storing, a first information I-1, which characterizes at least one cell C-1 and/or frequency of a radio access network notification area, RNA, which is overloaded for at least one slice associated with an existing PDU session PDU-SESS of the terminal device 20. In some embodiments, the means 202′ for receiving 350 the first information I-1 may e.g. comprise at least one processor 202, and at least one memory 204 storing instructions 206, the at least one memory 204 and the instructions 206 configured to, with the at least one processor 202, perform said step(s).

Further exemplary embodiments, FIG. 3, 9, relate to an apparatus 30, comprising at least one processor 32, and at least one memory 34 storing instructions 36, the at least one memory 34 and the instructions 36 configured to, with the at least one processor 32, cause a network node 10′ to transmit e2 (FIG. 8) a slice overload information SOI (also see FIG. 3 and FIG. 4, block 300) characterizing at least one of: a) an overload condition of a slice supported by a specific cell, b) an estimated duration of an overload condition of a slice supported by a specific cell. In some embodiments, this may enable a further network node, e.g. an anchor gNB, 10 to which the slice overload information SOI is transmitted, to provide the first information I-1 according to the embodiments, e.g. based on the received slice overload information SOI, to at least one terminal device 20.

Further exemplary embodiments relate to a method comprising: transmitting, by a network node 10′ (FIG. 3), a slice overload information SOI characterizing at least one of: a) an overload condition of a slice supported by a specific cell, b) an estimated duration of an overload condition of a slice supported by a specific cell.

Further exemplary embodiments, FIG. 12, relate to an apparatus 30′ comprising means 32′ for transmitting a slice overload information SOI characterizing at least one of: a) an overload condition of a slice supported by a specific cell, b) an estimated duration of an overload condition of a slice supported by a specific cell. In some embodiments, the means 32′ for transmitting the slice overload information SOI may e.g. comprise at least one processor 32, and at least one memory 34 storing instructions 36, the at least one memory 34 and the instructions 36 configured to, with the at least one processor 32, perform said step(s).

FIG. 8 schematically depicts a simplified signalling diagram according to some embodiments. Reference sign 10 denotes a network device such as an anchor gNB for the terminal, e.g. UE, 20. Reference signs 10′, 10″ denote further gNBs which, in some embodiments, may provide one or more cells for the radio access network notification area of the UE 20. As an example, gNB 10′ provides a cell “4” associated with a slice “1”, and gNB 10″ provides a cell “3” also associated with the slice “1”.

In some embodiments, it is assumed that the UE 20 has an existing PDU session 1 of slice “1” in RRC connected mode in the serving gNB, e.g. anchor gNB 10, see for example block e3 of FIG. 8. In some embodiments, the serving gNB 10 is made aware, e.g. through Xn signaling e1, e2, that neighbour cell “3”, see gNB 10″, which supports slice “1”, has slice “1” NOT overloaded, and that neighbour cell “4” (see gNB 10′), which supports also slice “1”, has slice “1” overloaded for a duration of at least 30 seconds.

In some embodiments, the serving gNB 10 may decide to move the UE 20 to RRC_Inactive state and may send an RRC Release message e4 with suspend indication and a configured RNA (RAN Notification Area). The serving gNB 10 provides a list of cells containing cell “4” (e.g. identified by PCI (Physical Cell ID) of cell 4) for which slice 1 is overloaded, for example to be considered as deprioritized for the UE 20, wherein the list of cells is e.g. transmitted within or in form of the first information, e.g. within the RRC Release message e4. In some embodiments, the RRC Release message e4 may also include the slice which is overloaded in cell 4 i.e. slice 1, and, additionally, may also include an estimated minimum duration of 30 seconds for the overload for slice 1 in cell 4, e.g. as a part of the first information, e.g. the duration information DUR, also see for example FIG. 5.

In some embodiments, block e5 of FIG. 8 symbolizes the UE 20, being in the RRC inactive state, moving within the RAN Notification Area. In some embodiments, the UE 20 has cells “3” and “4” as candidate for cell re-selection and selects cell 3, see block e6, taking into account, e.g. among other criteria, the first information I-1 received within the RRC Release message e4. In some embodiments, the UE 20 may then, e.g. later, trigger a service request for PDU session 1 and a RRC resume request e7 reaches the gNB 10″ serving cell “3”.

In some embodiments, the gNB 10″ of cell “3” may fetch a context from the last serving (e.g., anchor) gNB 10, see the arrows e8 of FIG. 8, and may recover PDU session 1 of slice 1, see block e9, which it continues because slice 1 is not overloaded for cell “3”.

Further embodiments, FIG. 3, relate to a communications system 1 comprising at least one apparatus 30, 30′, 100, 100′, 200, 200′ according to the embodiments.

Further embodiments relate to a computer program comprising instructions 36, 106, 206 which, when the program is executed by a computer, cause the computer to carry out the method according to the embodiments. In some embodiments, the computer program may be stored on a non-transitory computer readable storage medium 34, 104, 204.

Further embodiments relate to a data carrier signal carrying the computer program according to the embodiments.

Further embodiments relate to a use of the apparatus according to the embodiments and/or of the method according to the embodiments and/or of the computer program according to the embodiments and/or of the data carrier signal according to the embodiments for at least one of: a) providing at least one terminal device, e.g. user equipment, 20 with the first information I-1, b) increasing a probability of successful service continuity for the at least one terminal device 20, e.g. when reconnecting to a cell of the radio access network notification area, see for example elements e7, e8, e9 of FIG. 8, c) load balancing.

1-19. (canceled)

20. An apparatus, comprising at least one processor, and at least one memory storing instructions, the at least one memory and the instructions configured to, with the at least one processor, cause a network node at least to:
transmit first information to at least one terminal device,
wherein the first information characterizes at least one cell and/or frequency of a radio access network notification area, RNA, which is overloaded for at least one slice associated with an existing PDU session (PDU-SESS) of the at least one terminal device.

21. The apparatus according to claim 20, wherein the instructions, when executed by the at least one processor, cause the network node at least to:
receive slice overload information (SOI) characterizing at least one of: a) an overload condition of a slice supported by a specific cell, or b) an estimated duration of an overload condition of a slice supported by a specific cell.

22. The apparatus according to claim 20, wherein the instructions, when executed by the at least one processor, cause the network node at least to:
transmit the first information in a radio resource control, RRC, Release message.

23. The apparatus according to claim 20, wherein the first information comprises at least one of:
a) a list (LST) of cells of the radio access network notification area, RNA, which is overloaded for at least one slice associated with an existing PDU session of the at least one terminal device,
b) for at least one cell of a or the list of cells, slice information (SLI) identifying at least one overloaded slice of the at least one cell, or
c) an estimated duration (DUR) of an overload condition of a slice supported by a specific cell.

24. The apparatus according to claim 20, wherein the instructions, when executed by the at least one processor, cause the network node at least to:
determine, based on a threshold (THR) associated with a load of a specific cell, to which terminal devices the first information should be sent, and to transmit the first information to the determined terminal devices.

25. An apparatus, comprising at least one processor, and at least one memory storing instructions, the at least one memory and the instructions configured to, with the at least one processor, cause a terminal device at least to:
receive first information which characterizes at least one cell and/or frequency of a radio access network notification area, RNA, which is overloaded for at least one slice associated with an existing PDU session of the terminal device.

26. The apparatus according to claim 25, wherein the instructions, when executed by the at least one processor, cause the terminal device at least to:
perform a cell selection or cell re-selection taking into account the first information.

27. The apparatus of claim 26, wherein taking into account the first information comprises deprioritizing the at least one cell in the cell selection or re-selection.

28. The apparatus of claim 26, wherein taking into account the first information comprises deprioritizing the frequency of the at least one cell in the cell selection or re-selection.

29. An apparatus, comprising at least one processor, and at least one memory storing instructions, the at least one memory and the instructions configured to, with the at least one processor, cause a network node at least to:
transmit slice overload information characterizing at least one of: a) an overload condition of a slice supported by a specific cell, or b) an estimated duration of an overload condition of a slice supported by a specific cell.
